(19) United States
(12) Patent Application Publication
(10) Pub. No.: US 2005/0229800 A1
(43) Pub. Date: Oct. 20, 2005

(54) Plate cylinder with larger diameter central image area

(75) Inventors: John Sheridan Richards, Barrington, NH (US); Charles Reif Hammond, Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Heidelberger Druckmaschinen AG, Heidelberg (DE)

(21) Appl. No.: 10/827,970

(22) Filed: Apr. 20, 2004

(51) Int. Cl. B41F 13/10

(52) U.S. Cl. 101/375; 101/216

(57) ABSTRACT

A plate cylinder has a cylinder body, a first image area at one end of the cylinder body, the first image area having a first average diameter, a second image area at the other end of the cylinder body having a second average diameter, and a third image area between the first and second image areas. The third image area has a third average diameter larger than the first and second average diameters. A print unit, web offset printing press and a plate bender are also provided.

### BACKGROUND INFORMATION

The present invention relates generally to offset printing and more specifically to a plate cylinder for an offset printing press and related plate bender.

U.S. Pat. No. 4,487,122 discloses a system for compensating for roll deflection to provide contact pressure across the width of a web disposed between a pair of counter rollers. U.S. Pat. No. 5,094,163 discloses a rotogravure press with electrically conductive layers. U.S. Pat. No. 5,913,266 and U.S. Patent Publication No. 2003/0061955 disclose plate cylinders, and are hereby incorporated by reference herein. U.S. Pat. Nos. 6,283,027 and 6,105,498 disclose varying profile blankets, including printing blankets with concave and convex profiles. A concave blanket cylinder is also disclosed.

U.S. Pat. No. 5,987,949 discloses a plate bender and is hereby incorporated by reference herein.

### BRIEF SUMMARY OF THE INVENTION

Especially with multi-image width printing presses, deflection at the middle of the plate and blanket cylinders can provide problems with printing a web. For example, the middle of the web may be printed too lightly.

U.S. patent application Ser. No. 10/617,639, filed Jul. 11, 2003 and hereby incorporated by reference herein, discloses a printing blanket comprising a carrier sleeve layer having at least one axially convex surface when disposed on a blanket cylinder and a print layer disposed over the carrier sleeve layer. In this application, the convexity of the carrier sleeve layer may be provided, for example, by having the carrier sleeve layer have a uniform inner diameter and a convex outer diameter. The carrier sleeve layer itself is thus thicker in an axial middle than at the ends. Alternately, the carrier sleeve can be of uniform thickness, and the blanket cylinder or a shim may provide the surface convexity.

Crowning of blankets or a blanket cylinder to have a larger diameter can result to fan-in, i.e. a lateral squeezing together of the web and thus the print, during printing.

The present invention provides a plate cylinder comprising a cylinder body, a first image area at one end of the cylinder body, the first image area having a first average diameter, a second image area at the other end of the cylinder body having a second average diameter, and a third image area between the first and second image areas, the third image area having a third average diameter, the third average diameter being larger than the first and second average diameters.

By having a larger diameter image area in the middle of the plate cylinder, print pressure or squeeze can be increased at the center of the web.

Each image area may comprise two side-by side images, so that the plate cylinder is six images wide. Preferably, each image area supports a single image in the circumferential direction. A one-by-six plate cylinder thus may be provided. However, any ratio of one-by-three or greater plate cylinder may be provided, for example a two-by-six plate cylinder. Ratios of one-by-four or greater are preferred, as increased widths create more need for increased print pressure. A ratio of one-to-six is possible, and a ratio of one-to-six or greater may be most preferable.

One or more printing plates may be attached at each image area.

The first and second image areas may have a constant diameter, as may the third image area. However, the image areas may be of non-constant diameter, for example crowned or conically shaped to provide the different average diameters.

The cylinder body may have a larger diameter middle section so that the third average diameter is larger than the end section.

Alternatively, packing may be applied to increase the diameter of a printing plate or plates in the third image area. As another alternative, the plates used in the third image area may be thicker than plates used in the first and second image areas. In these cases, the cylinder body may have a uniform diameter.

An offset printing press comprising the plate cylinder and a blanket cylinder is also provided. Preferably, the blanket cylinder has an effective blanket diameter which is uniform to reduce fan-in.

A plate bender for printing plates for use on the plate cylinder of the present invention is also provided, the plate bender including a movable section for altering the effective post-bending length of the plate as a function of an intended axial position of the plate on the plate cylinder.

The present invention also provides a plate bender for printing plates having a movable section skewable with respect to the plate. The movable section may be curved to fit with a crowned plate cylinder.

Plate cylinder as defined herein includes a directly imaged cylinder where images are written directly on the outer surface of the cylinder, for example by a laser. While the printing plates preferably are flat lithographic printing plates, for certain embodiments, the printing plates may also be tubular in nature.

### BRIEF DESCRIPTION OF THE DRAWINGS

The present invention will be further described with respect the following Figures, in which:

FIG. 1 shows schematically a first embodiment of the printing press of the present invention with a plate cylinder having a larger diameter cylinder body middle image area;

FIGS. 2 and 3 show an alternate plate cylinders with a uniform diameter cylinder body, FIG. 2 having packing underneath the middle image area and FIG. 3 having thicker plates in the middle image area;

FIGS. 4 and 5 show crowned and conical plate cylinder image areas, respectively;

FIG. 6 shows a schematic top view of a plate bender according to the present invention; and

FIGS. 7 and 8 show two partial side views of the plate bender.

### DETAILED DESCRIPTION

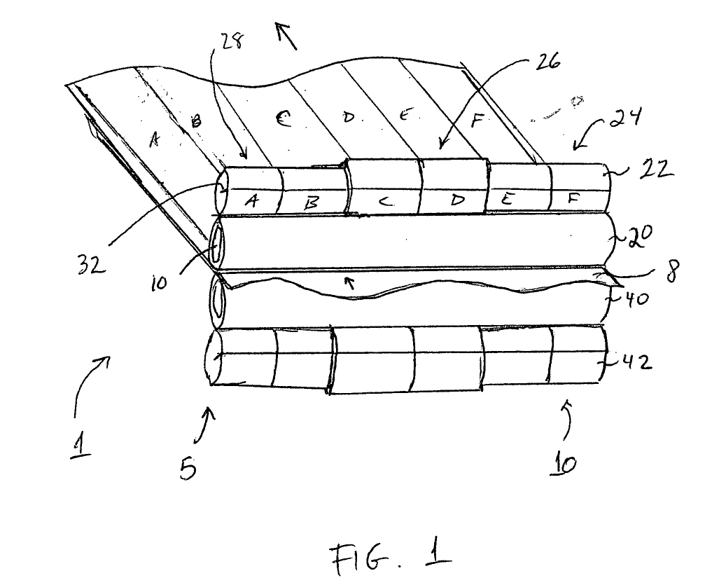

FIG. 1 shows schematically a print unit 5 of an exemplary offset lithographic web printing press 1 with a blanket cylinder 10 having a uniform radius outer surface 11 for printing a web 8. A compressible blanket 20 fits over blanket cylinder 10, for example by sliding axially. The blanket or blanket cylinder may have a uniform or profiled outer surface.

A one-by-six plate cylinder 22 may have an image area 24 having two side-by-side images E, F, an image area 28 having two side-by-side images A, B and a middle image area 26 having two side-by-side images C, D, all of which are transferred via the blanket cylinder 20 to the web 8 as shown. The plate cylinder body, which may be made for example of steel and have axially-extending plate lock-up gaps 32, has a larger diameter at image area 26. This can be achieved for example through milling the cylinder body at areas 24, 28 to reduce the diameter. Six flat lithographic printing plates may be attached to the respective image areas via gaps 32, the plates having images A, B, C, D, E, F respectively. Alternately the images can be directly imaged on the plate cylinder.

Circumferential and/or lateral registration for each plate or image area may be provided, for example via a mechanism as disclosed in U.S. Pat. No. 6,559,908, which is hereby incorporated by reference herein.

A similar blanket 40 and plate cylinder 42 may be provided for the opposite side of web 8.

The diameter difference is exaggerated for clarity in FIG. 1. The larger diameter of image area 26 increases print pressure at the center of blankets 20, 40. Although some part of images B, E close to images C, D face reduced pressure due to the raised nature of the area 26, the increased diameter of section 26 may be selected so that the compressible nature of blanket 20 and print pressure variation of the entire width provide adequate print pressure for all of images B and E. It is also noted that non-printed lateral areas typically extend between the image areas A, B, C, D, E, F.

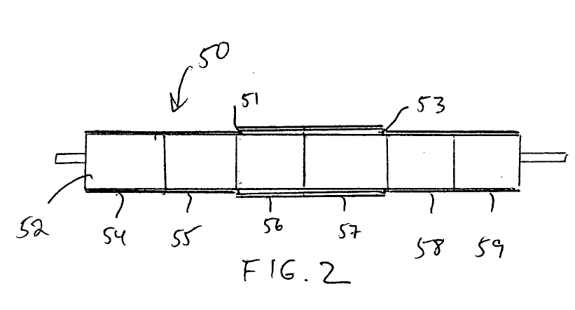

FIG. 2 shows an alternate embodiment of a plate cylinder 50 having a plate cylinder body 52 with a uniform outer diameter. Plates 54, 55, 58 and 59 all have a same diameter while plates 56, 57 have a larger effective diameter when placed on cylinder body 52 via packing materials 51, 53. MYLAR for example in tape or sheet form may be used as a packing material. The plates may be directly imaged on the cylinder 50.

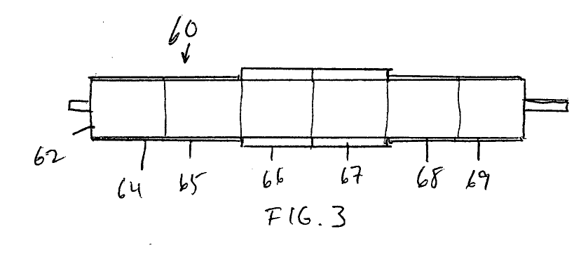

FIG. 3 shows an alternate embodiment of a plate cylinder 60 having a plate cylinder body 62 with a uniform outer diameter. Plates 64, 65, 66, 67, 68 and 69 all have a same inner diameter while plates 66 and 67 have a larger outer diameter than plates 64, 65, 68, 69 due to an increased thickness. The plates 64, 65, 66, 67, 68, 69, while preferably flat, could also be manufactured as tubes and slid axially onto the plate cylinder body 62. The plates may be directly imaged on the cylinder 50.

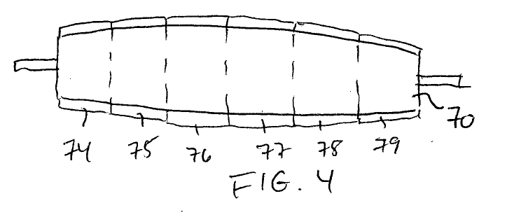

FIG. 4 shows a crowned plate cylinder 70, the crowning being exaggerated for clarity. Plates 74, 75, 76, 77, 78 and 79 can be attached to the plate cylinder, although direct imaging is also possible.

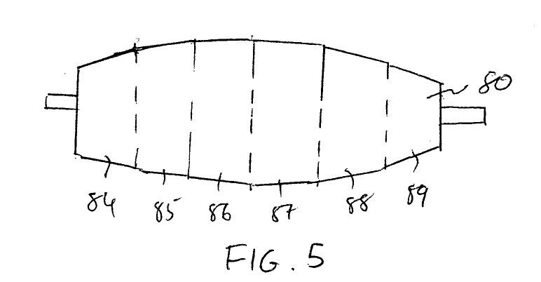

FIG. 5 shows a conically-sectioned plate cylinder, the conical sections being angled in an exaggerated manner for clarity. Image areas 84, 85, 86, 86, 88 and 89 may be provided for example by plates attached to the image areas or by direct imaging.

The crowning or conical shape may be achieved for example through milling.

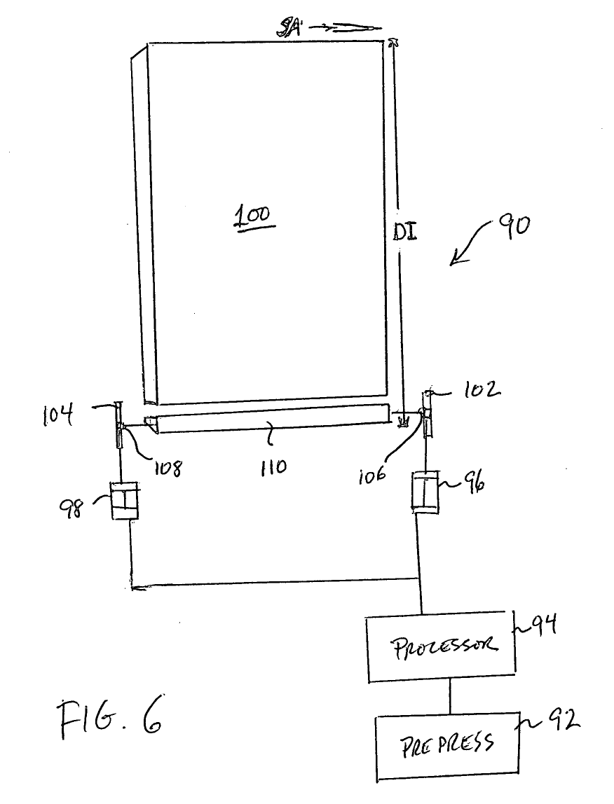

FIG. 6 shows a plate bender 90 according to the present invention. Images may be imaged in a prepress imaging station 92 on the plates for the plate cylinder 22, and the images may all have a similar size.

Through prepress 92, the desired axial location for each plate on the plate cylinder 22 is known, i.e. whether the plate is to print image A, B, C, D, E or F for one color.

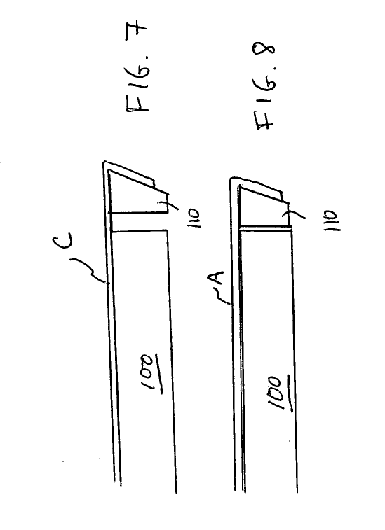

A processor 94 then controls the plate bender 90 so that a distance DI is altered. Pistons 96, 98 for example can move a base bar 110 with respect to a plate base 100 via tracks 102, 104. As shown in exaggerated fashion in FIGS. 7 and 8, for a plate carrying image C the distance DI is larger than for the plate carrying image A, which is on a smaller diameter section of plate 22. The axially-extending lock-up gaps 32 in the plate cylinder 22 hold the bent section of the plate and thus fasten the plates to the plate cylinder 22. An overhead anvil may be provided to bend the plate edge about the base bar 110.

For the embodiment of FIG. 5, the plate bender 90 may have an extra base bar opposite the base bar 110 and also controlled by the processor 94. Hinges 106, 108 may be provided between track 102, 104 and the base bar 110 to permit a skewing of the base bar 110 with respect to base 100 to create a skew angle SA, which can correspond to the conical angle for a section 84, 85, 86, 87 or 88 on plate cylinder 80.

For the embodiment of FIG. 4, the base bar 110 and the bar opposite base 100 may be rounded at the bend edge to match the crowning curvature.

“Crowned” as defined herein means to have an outer surface curved convexly with respect to a cylinder rotational axis.

1. A plate cylinder comprising:
a cylinder body;
a first image area at one end of the cylinder body, the first image area having a first average diameter;
a second image area at the other end of the cylinder body having a second average diameter; and
a third image area between the first and second image areas, the third image area having a third average diameter, the third average diameter being larger than the first and second average diameters.

2. The plate cylinder as recited in claim 1 wherein the first and second average diameters are the same.

3. The plate cylinder as recited in claim 1 wherein the first image area, second image area, and third image area each carry two side-by-side images.

4. The plate cylinder as recited in claim 1 further comprising a first printing plate for attachment in the first image area, a second printing plate for attachment in the second image area, and a third printing plate for attachment in the third image area.

5. The plate cylinder as recited in claim 4 further comprising a fourth printing plate for attachment in the third image area.

6. The plate cylinder as recited in claim 5 further comprising a fifth printing plate for attachment in the first image area.

7. The plate cylinder as recited in claim 1 wherein the first image area has a single image in the circumferential direction.

8. The plate cylinder as recited in claim 1 wherein the first area has a constant diameter equal to the first average diameter over an axial extent of the first image area.

9. The plate cylinder as recited in claim 8 wherein the third image area has a further constant diameter equal to the third average diameter over an axial extent of the third image area.

10. The plate cylinder as recited in claim 1 wherein the first image area is crowned.

11. The plate cylinder as recited in claim 1 wherein the third image area is crowned.

12. The plate cylinder as recited in claim 1 wherein the first, second, and third image areas are crowned.

13. The plate cylinder as recited in claim 1 wherein the third image area includes a first conically-shaped section.

14. The plate cylinder as recited in claim 13 wherein the third image area includes a second conically-shaped section opposed to the first conically-shaped section so as to define a largest diameter of the plate cylinder.

15. The plate cylinder as recited in claim 1 wherein the cylinder body has a larger diameter middle section larger than a diameter of either the one end or the other end of the cylinder body.

16. The plate cylinder as recited in claim 1 further comprising packing around the cylinder body at the third image area, and at least one printing plate placed over the packing.

17. The plate cylinder as recited in claim 4 wherein the third printing plate is thicker than the first and second printing plates.

18. An offset print unit comprising the plate cylinder as recited in claim 1 and a blanket cylinder with a compressible blanket contacting the plate cylinder.

19. An offset web printing press comprising a web, a plate cylinder as recited in claim 1 and a blanket cylinder with a compressible blanket contacting the plate cylinder and the web.

20. A plate bender for a printing plate for use on the plate cylinder of claim 1, the plate bender comprising:
a processor receiving information on an intended axial position of the printing plate on the plate cylinder; and
a movable section for altering the effective post-bending length of the plate as a function of the intended axial position of the plate.

21. A plate bender for a printing plate comprising:
a base for supporting the plate; and
a movable section skewable with respect to the base.
